(19) United States
(12) Patent Application Publication
(10) Pub. No.: US 2007/0137966 A1
(43) Pub. Date: Jun. 21, 2007

(54) Electrohydraulic clutch assembly

(75) Inventors: Philip J. Francis, Lapeer, MI (US); Christopher J. Kowalsky, Windsor (CA); Mark A. Perlick, Shelby Township, MI (US); Tsunlock A. Yu, Saline, MI (US); Larry A. Pritchard, Macomb, MI (US)

Correspondence Address: BORGWARNER INC., PATENT DEPARTMENT, 3850 HAMLIN ROAD, AUBURN HILLS, MI, 48326-2872, US

(73) Assignee: BorgWarner Inc.

(21) Appl. No.: 11/641,132

(22) Filed: Dec. 19, 2006

Related U.S. Application Data
(63) Continuation-in-part of application No. 10/788,621, filed on Feb. 27, 2004, now abandoned.

(51) Int. Cl. F16D 29/00

(52) U.S. Cl. 192/20; 192/84.6; 192/85 CA

(57) ABSTRACT

An electrohydraulic clutch includes a bidirectional electric motor, a hydraulic circuit and a multiple plate friction clutch pack. The bidirectional electric motor drives a ball screw through a gear reduction assembly. An electric brake on the motor output may be energized to inhibit its rotation. Alternatively, an anti-back drive wrap-spring assembly may be utilized on the motor output. The ball screw output bi-directionally translates a master piston of the hydraulic circuit which in turn advances and retracts an annular slave piston disposed adjacent the friction clutch pack. Hence, actuation of the electric motor displaces hydraulic fluid and compresses or relaxes the friction clutch pack, thereby transferring or inhibiting torque.

### BACKGROUND OF THE INVENTION

The invention relates generally to an electrohydraulic clutch and more specifically to an electrohydraulic clutch having an electric motor, a hydraulic fluid circuit and a multiple plate friction clutch pack.

Clutches which are activated or energized by electromagnetic coils are extraordinarily common components in rotary power transmission systems, both in stationary applications and in motor vehicles. Such electromagnetic clutches may be broadly characterized by whether they provide on-off energy transfer or modulating energy transfer. In the case of the former, dog clutches which may include auxiliary synchronizing devices or twin plate, i.e., drive and driven, clutches are utilized whereas in the latter, friction clutch packs having a plurality of interleaved friction plates or discs are utilized. In either case, an electromagnetic operator which translates or compresses components of the clutch upon energization activates the clutch and upon deenergization deactivates or relaxes the clutch.

One of the design and operational characteristics of electromagnetic clutches which receives significant engineering attention is power consumption. It is desirable, especially in motor vehicles, to design and utilize a clutch having low power consumption. Low power consumption is desirable in and of itself but it also reduces the heat generated by the coil and thus lower power consumption can reduce the need for cooling the coil, can improve the service life of the coil and is therefore overall a desirable design goal.

Another design consideration may be broadly characterized as control. It is desirable for motor vehicle drive line clutches to both engage smoothly and preferably imperceptibly and also modulate accurately in proportion to the control signal, that is, exhibit close correspondence between the magnitude of the electrical drive signal (representing the desired proportion of clutch engagement) and the actual clutch engagement.

The present invention is directed to these design goals.

### SUMMARY OF THE INVENTION

An electrohydraulic clutch includes a bi-directionally rotatable electric motor, a hydraulic circuit and a multiple plate friction clutch pack. The electric motor drives a ball screw through a multiple gear speed reduction assembly. The ball screw output translates a master piston of the hydraulic circuit which in turn advances and retracts an annular slave piston disposed adjacent the friction clutch pack. Hence, actuation of the electric motor displaces hydraulic fluid and compresses or relaxes the friction clutch pack. In one embodiment, an anti-back drive assembly disposed between the motor and gear reduction assembly includes a wrap spring disposed between two hubs and contained within a cylindrical aperture or housing. In another embodiment, an electric brake is disposed about the output shaft of the motor and may be selectively energized to inhibit rotation of the motor and gear reduction assembly.

It is a still further object of the present invention to provide an electrohydraulic clutch having an electric motor and electric brake.

It is thus an object of the present invention to provide an electrohydraulically actuated friction clutch.

It is a further object of the present invention to provide an electrohydraulic clutch including a multiple plate friction clutch assembly.

It is a still further object of the present invention to provide an electrohydraulic clutch having an electric motor and anti-back drive assembly.

It is a still further object of the present invention to provide an electrohydraulic clutch for use in transfer cases, rear axles and other motor vehicle drive line components.

Further objects and advantages of the present invention will become apparent by reference to the following description of the alternate and preferred embodiments and appended drawings wherein like reference numbers refer to the same component, element or feature.

### BRIEF DESCRIPTION OF THE DRAWINGS

FIG. 1 is a diagrammatic view of a four-wheel drive motor vehicle power train having an electrohydraulic clutch assembly according to the present invention utilized in conjunction with a rear differential;

FIG. 2 is a full, sectional view of an alternate embodiment electrohydraulic clutch assembly according to the present invention taken along line 2-2 of FIG. 1;

FIG. 3 is a full, sectional view of an alternate embodiment electrohydraulic clutch assembly according to the present invention taken along line 3-3 of FIG. 1;

FIG. 4 is a full, sectional view of a preferred embodiment electrohydraulic clutch assembly according to the present invention taken along line 2-2 of FIG. 1; and

FIG. 5 is a full, sectional view of a preferred embodiment electrohydraulic clutch assembly according to the present invention taken along line 3-3 of FIG. 1.

### DETAILED DESCRIPTION OF THE PREFERRED AND ALTERNATE EMBODIMENTS

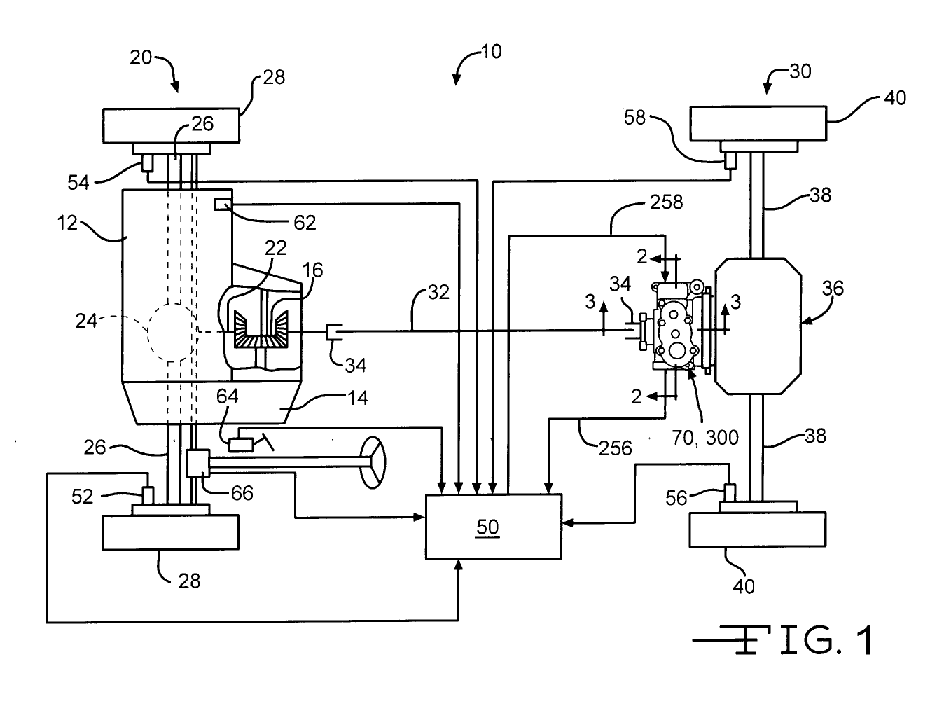

Referring now to FIG. 1, a four-wheel vehicle drive train incorporating the present invention is diagrammatically illustrated and designated by the reference number 10. The four-wheel vehicle drive train 10 includes a prime mover 12 such as an internal combustion gas or Diesel engine or hybrid power plant which is coupled to and directly drives a transaxle 14. The output of the transaxle 14 drives a bevel or spiral bevel gear set 16 which provides motive power to a primary or front drive line 20 comprising a front or primary propshaft 22, a front or primary differential assembly 24, a pair of live front axles 26 and a respective pair of front or primary tire and wheel assemblies 28. It should be appreciated that the front or primary differential 24 is conventional.

The bevel or spiral bevel gear set 16 also provides motive power to a secondary or rear drive line 30 comprising a secondary propshaft 32 having appropriate universal joints 34, a rear or secondary differential assembly 36, a pair of live secondary or rear axles 38 and a respective pair of secondary or rear tire and wheel assemblies 40.

The foregoing description relates to a vehicle wherein the primary drive line 20 is disposed at the front of the vehicle and, correspondingly, the secondary drive line 30 is disposed at the rear of the vehicle, such a vehicle commonly being referred to as a front wheel drive vehicle or adaptive front wheel drive vehicle. The designations “primary” and “secondary” utilized herein refer to drive lines providing drive torque at all times and drive lines providing supplemental or intermittent torque, respectively. These designations (primary and secondary) are utilized herein rather than front and rear inasmuch as the invention herein disclosed and claimed may be readily utilized with vehicles wherein the primary drive line 20 is disposed at the rear of the vehicle and the secondary drive line 30 and components associated with the secondary differential assembly 36 are disposed at the front of the vehicle.

Thus, the illustration of FIG. 1, wherein the primary drive line 20 is disposed at the front of the vehicle should be understood to be illustrative rather than limiting and that the components and the general arrangement of components illustrated is equally suitable and usable with a primary rear wheel drive vehicle.

Associated with the vehicle drive train 10 is a controller or microprocessor 50 which receives signals from a plurality of sensors and provides a control, i.e., actuation, signal to an alternate or preferred embodiment electrohydraulic clutch assembly 70, 300 operably disposed before the secondary differential assembly 36. Specifically, a first sensor such as a Hall effect or variable reluctance sensor 52 senses the rotational speed of the left primary (front) tire and wheel assembly 28 and provides an appropriate signal to the microprocessor 50. Similarly, a second Hall effect or variable reluctance sensor 54 senses the rotational speed of the right primary (front) tire and wheel assembly 28 and provides a signal to the microprocessor 50. A third Hall effect or variable reluctance sensor 56 senses the rotational speed of the left secondary (rear) tire and wheel assembly 40 and provides a signal to the microprocessor 50. Finally, a fourth Hall effect or variable reluctance sensor 58 associated with the right secondary (rear) tire and wheel assembly 40 senses its speed and provides a signal to the microprocessor 50. It should be understood that the speed sensors 52, 54, 56 and 58 may be independent, i.e., dedicated, sensors or may be those sensors mounted in the vehicle for anti-lock brake systems (ABS) or other traction control, or stability vehicle systems. It should also be understood that an appropriate and conventional counting or tone wheel is associated with each of the speed sensors 52, 54, 56 and 58 although they are not illustrated in FIG. 1.

The controller or microprocessor 50 may also receive information from other sensors or a CAN bus regarding vehicle operating variables and conditions. For example, an engine speed sensor 62 may be utilized to provide a real time signal to the microprocessor 50 regarding the speed of the engine 12. Additionally, a throttle position sensor 64 may be included to provide a real time signal to the microprocessor 50 regarding the degree or extent of activation of the accelerator pedal. Furthermore, a steering angle sensor 66 may be utilized to provide real time data to the microprocessor 50 regarding the angular position of the steering column, the lateral position of the steering rack or the angular position of the front tire and wheel assemblies 28. The controller or microprocessor 50 includes software which receives and conditions the signals from the sensors 52, 54, 56 and 58 as well as the optional sensors 62, 64 and 66, determines corrective action to improve the stability of the vehicle, maintain control of the vehicle and/or correct or compensate for a skid or other anomalous operating condition and provides an output signal to the alternate and preferred embodiment electrohydraulic clutch assemblies, 70, 300.

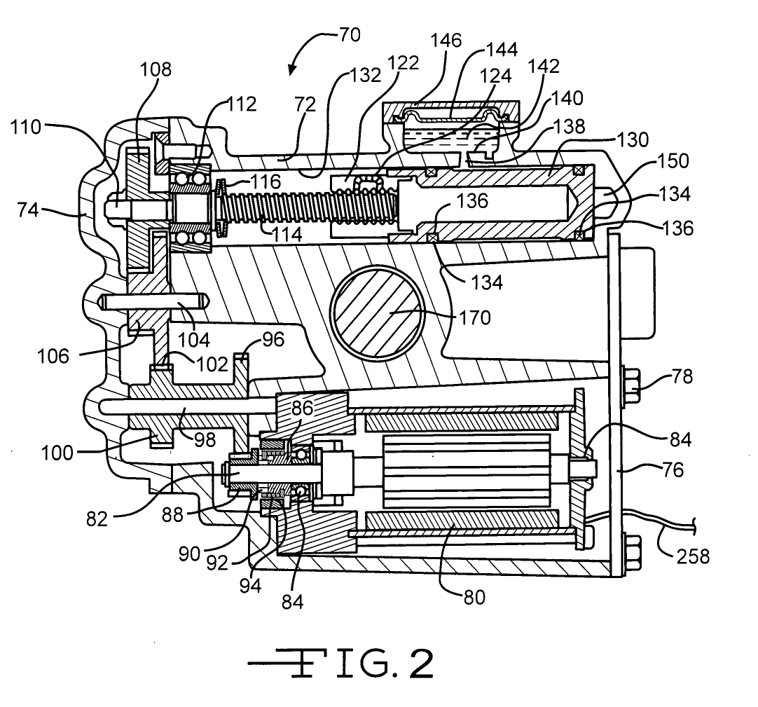

Referring now to FIG. 2, the alternate embodiment electrohydraulic clutch assembly 70 includes a preferably metal housing 72 having various bores, ports, slots, faces, passageways and the like which receive the various components thereof. A first end plate 74 is especially formed to receive various shafts, fits tightly on one end face of the housing 72 and is secured thereby a plurality of fasteners (not illustrated). A second end plate 76 is secured to the other end face of the housing 72 by a plurality of fasteners 78. Disposed within a suitably sized region of the housing 72 is a bi-directional, fractional horsepower electric motor 80. The electric motor 80 includes an output shaft 82 which is supported upon suitable bearings 84 and includes a drive hub 86 having a diametric vane. A driven pinion gear 88 which is freely rotatably disposed on the output shaft 82 includes two-axially extending lugs 90. The lugs 90 engage opposite sides or faces of the vaned drive hub 86 thus allowing limited (approximately 150° to 160°) angular relative rotation between the vaned drive hub 86 and the pinion gear 88. A wrap spring 92 is wrapped about and extends between the vaned drive hub 86 and the lugs 90 and the pinion gear 88.

The wrap spring 92 is received within a relatively closely fitting cylindrical aperture or passageway 94 which may be formed in the housing 72 or may be a bore or passageway in a stationary collar or similar component. The wrap spring 92, the associated drive hub 86 and the pinion gear 88 cooperate to accommodate bidirectional drive of the pinion gear 88 by the motor 80 as the lugs 90 engage and thus achieve direct drive of the pinion gear 88 by the vaned drive hub 86. However, when electrical power to the electric motor 80 is terminated, and forces attempt to back drive the electric motor 80, the wrap spring 92 is unwound by rotation of the pinion gear 88. As the wrap spring 92 is unwound and expands, it engages the surface or wall of the aperture or passageway 94 thus inhibiting further reverse rotation of the pinion gear 88.

The pinion gear 88 is in constant mesh with a first spur gear 96. The first spur gear 96 is supported upon a first shaft 98 and is coupled to or integrally formed with a smaller diameter second pinion gear 100 which is in constant mesh with a second spur gear 102. The second spur gear 102 is likewise rotatably supported upon a second stub shaft 104. The second spur gear 102 is coupled to or preferably integrally formed with a third pinion gear 106. The third pinion gear 106 is in constant mesh with and drives a third spur gear 108 which is secured to a drive shaft 110.

The drive shaft 110 is preferably supported by a pair of anti-friction bearings such as roller bearing assemblies 112. The drive shaft 110 includes a ball screw portion 114. Between the drive shaft 110 and the ball screw portion 114 are mounted a plurality of Belleville springs or washers 116 that function as a resilient stop. Disposed about the ball screw portion 114 is a recirculating ball nut 122. The recirculating ball nut 122 includes a plurality of balls or roller bearings 124 which recirculate about the complementarily configured grooves in the ball screw 114 and thus provide a low friction interconnection between the ball screw 114 and the nut 122. As the shaft 110 bi-directionally rotates in response to bidirectional rotation of the output shaft 84 of the electric motor 80, the recirculating ball nut 122 translates to the left and right. The ball screw 114 and the recirculating ball nut 122 thus function as a rotary to linear motion transducer.

The recirculating ball nut 122 is coupled to a master piston 130 which translates axially within an elongate cylinder 132 which also contains the lead screw portion 114. The master piston 130 includes a pair of O-ring seals 134 which are received within suitably configured circumferential grooves 136 near each end of the master piston 130. The master piston 130 is shown in FIG. 2 in its fully advanced or extended position. As the master piston 130 is retracted by rotation of the ball screw 114, it passes a port 138 which communicates with a fluid reservoir 140. The fluid reservoir 140 is preferably maintained substantially full of a hydraulic fluid 142 such that the cylinder 132 may be fully filled with hydraulic fluid when the piston 130 is retracted. A flexible seal 144 accommodates changes in volume of the hydraulic fluid 142 and a metal plate or cap 146 secures the flexible seal 144 and maintains a fluid tight seal thereabout. The elongate cylinder 132 narrows to a first fluid passageway 150 which provides for communication and flow of the hydraulic fluid 142 to the driven components of the electrohydraulic clutch assembly 70.

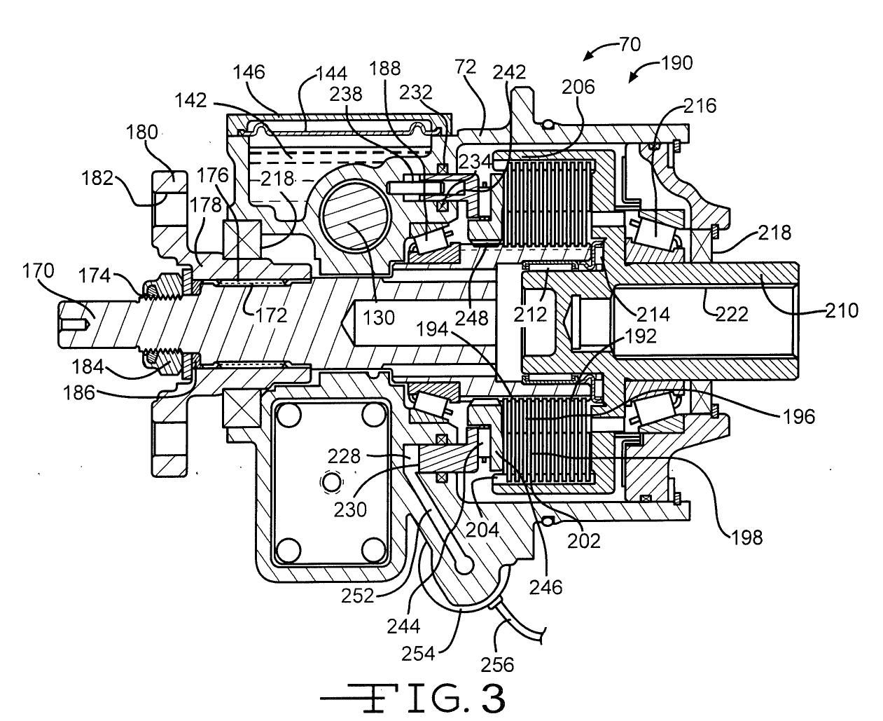

Turning now to FIG. 3, the electrohydraulic clutch assembly 70 includes an input shaft 170 preferably including a set of external or male splines or gear teeth 172 and a smaller diameter threaded region 174. The male or external splines or gear teeth 172 are engaged by complementarily configured female splines or gear teeth 176 formed on the interior of a cylindrical region 178 of a flange 180. The flange 180 preferably includes a plurality of through apertures 182 which may receive threaded fasteners or other components (not illustrated) associated with a drive component to the electrohydraulic clutch assembly 70 such as a universal joint 34, illustrated in FIG. 1. A retaining nut 184 as well as one or more flat washers 186 may be utilized to positively retain the flange 180 upon the input shaft 170. A tapered roller bearing assembly 188 rotatably supports the input shaft 170 within the housing 72 of the electrohydraulic clutch assembly 70.

The electrohydraulic clutch assembly 70 also includes a multiple plate friction clutch pack assembly 190. Driving the friction clutch pack assembly 190 are a plurality of male or external splines or teeth 192 disposed on the input shaft 170 which engage complementarily configured female splines 194 on a first plurality of smaller diameter friction clutch plates or discs 196. The first plurality of friction clutch plates or discs 196 are interleaved with a second plurality of larger diameter friction clutch plates or discs 198. The friction clutch plates or discs 196 and 198 include suitable clutch paper or friction material in accordance with conventional practice. Each of the second plurality of larger diameter friction clutch plates or discs 198 includes male or external splines 202 which engage and drive complementarily configured female or internal splines 204 formed on the interior of a cylindrical portion 206 of an output shaft 210. The output shaft 210 is rotationally isolated from and stabilized within a portion of the input shaft 170 by a roller bearing assembly 212. A thrust bearing assembly 214 is also disposed between the input shaft 170 and the output shaft 210 which is further supported by a tapered roller bearing assembly 216. Suitable oil seals 218 prevent the ingress of foreign matter and maintain a fluid tight seal between the housing 72, the input shaft 170 and the output shaft 210.

The output shaft 210 preferably includes internal or female splines or gear teeth 222 which are complementary to and engage suitably configured male splines or gear teeth on a shaft (not illustrated) disposed within the rear differential assembly 36 which receive torque from the electrohydraulic clutch assembly 70.

The first fluid passageway 150 illustrated in FIG. 2 communicates with an annular cylinder 228 which receives an annular slave piston 230. A first outer O-ring 232 and a second inner O-ring 234 disposed within suitable annular grooves provide a fluid tight seal between the side walls of the cylinder 228 and the annular slave piston 230. A register pin 238 seats within a complementarily configured blind aperture 242 in the annular slave piston 230 and inhibits rotation of the annular piston 230 within the annular cylinder 228. The annular piston 230 engages a thrust bearing 244 which permits relative rotation between the annular piston 230 and a circular apply plate 246. The circular apply plate 246 transfers axial motion and force generated by the annular piston 230 to the friction clutch pack assembly 190. The apply plate 246 includes female or internal splines 248 which are complementary to and engage the male splines 192 on the input shaft 170. Thus, the apply plate 246 rotates with the input shaft 170.

A second fluid passageway 252 provides communication between the cylinder 228 and a fluid pressure sensor or transducer 254. The pressure fluid sensor or transducer 254 is preferably a piezoelectric device which provides a signal in a single or multiple conductor cable 256 to the microprocessor 50 regarding the real time hydraulic fluid pressure within the cylinder 228. Electrical energy is provided to the electric motor 80 through a single or multiple conductor cable 258 illustrated in FIGS. 1 and 2.

The operation of the alternate embodiment electrohydraulic clutch assembly 70 will now be described with reference to FIGS. 1, 2 and 3. As noted, signals are preferably provided by the wheel speed sensors, 52, 54, 56 and 58 and the other sensors 62, 64 and 66 to the microprocessor 50. The microprocessor 50 provides a signal in the cable 258 to the electric motor 80 commanding it to rotate in one of two directions to increase or decrease the pressure of the hydraulic fluid 142 and thus the torque transferred through the friction clutch pack assembly 190. If the command from the microprocessor 50 is to increase torque throughput, the electric motor 80 rotates in a direction to advance the recirculating ball nut 122 and advance the master piston 130 within the elongate cylinder 132. As the master piston 130 translates, hydraulic fluid 142 is transferred, its pressure increases and the annular slave piston 230 translates, compressing the friction clutch pack assembly 190. A command from the microprocessor 50 to reduce torque transferred through the friction clutch pack assembly 190 results in the opposite action.

As noted above, the wrap spring 92 inhibits back driving of the electric motor 80 by the hydraulic pressure exerted on the master piston 130 and the lead screw portion 114. This is achieved, as also noted above, by the expansion of the wrap spring 92 and grounding or contact with the surface of the cylindrical aperture or passageway 94 as it is driven in a direction which both unwinds it and corresponds to retraction of the master piston 130. The prevention of back driving and thus the maintenance of a given pressure of the hydraulic fluid 142 and corresponding torque delivery through the friction clutch pack assembly 190 allows the electric motor 80 to be de-energized after it has achieved a desired position and fluid pressure thereby conserving electrical power. In this regard, it should also be noted that the pressure transducer 254 provides information to the microprocessor 50 regarding the current, actual pressure of the hydraulic fluid 142 which corresponds to a level of torque throughput. Such information may be utilized by the microprocessor 50 to adjust, in real time, the electrical energy delivered to the electric motor 80 to achieve a desired torque throughput.

Finally, it should be noted that the design of the housing 72 as well as the arrangement of components provides a passive oiling or lubrication system to the various components within the electrohydraulic clutch assembly 70. Thus, not only is the need for specific lubricating means such as a pump avoided but the assembly exhibits improved durability and service life.

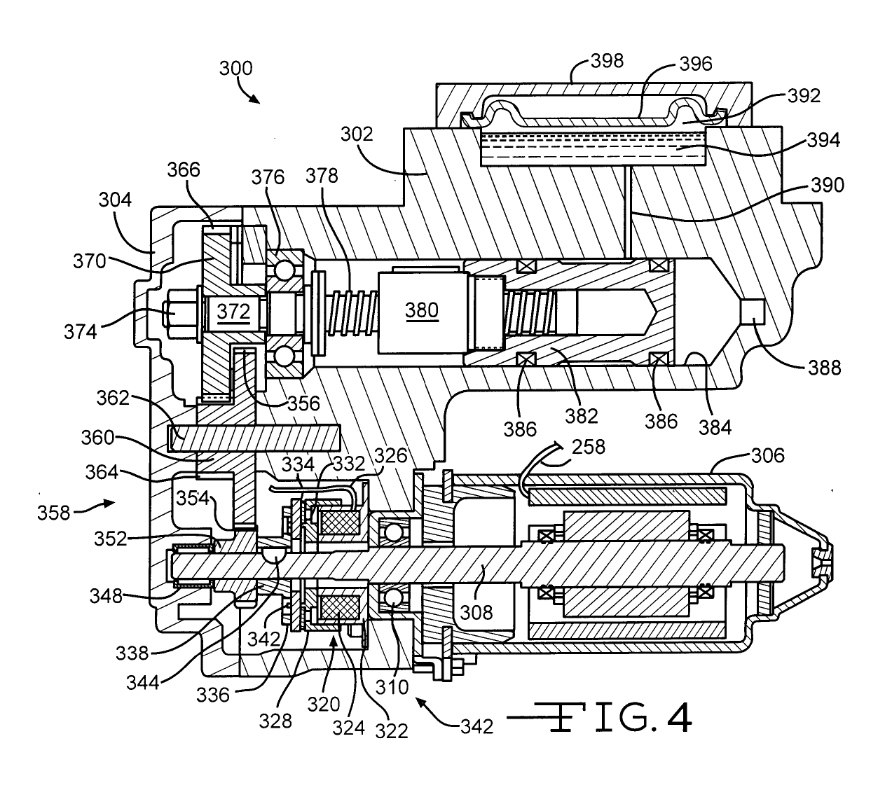

Referring now to FIG. 4, the preferred embodiment electrohydraulic clutch assembly 300 includes a preferably cast metal housing 302 having various openings, passageways, slots, faces, ports and the like which receive and support the various components thereof. An end plate 304 is likewise specially configured to receive various shafts, provide clearance for other components and securely seal one end face of the housing 302 and is secured thereto by a plurality of fasteners (not illustrated). Secured to the housing 302 by any suitable means is a bi-directional, fractional horsepower electric motor 306. The electric motor 306 includes an output shaft 308 which may be supported by one or more ball bearing assemblies 310.

Disposed about the output shaft 308 and within the housing 302 is an electric brake assembly 320. The electric brake assembly 320 includes a stationary annular housing 322 which contains and partially surrounds an electromagnetic coil 324. The electromagnetic coil 324 is supplied with electricity through a single or multiple conductor cable 326. Extending radially across the open end of the annular housing 322 and axially along a portion of its exterior is a stationary cup-shaped housing member 328. The housing member 328 may be fabricated of magnetically active material to concentrate magnetic flux from the electromagnetic coil 324 and may include discontinuous, arcuate flux directing slots 332. Adjacent the front surface of the housing member 328 is an annular disc or washer 334 of a friction material. The friction material disc 334 may be secured to either the front surface of the housing member 328 or to the adjacent flat surface of a flange 336 of a brake rotor 338. The brake rotor flange 336 preferably includes discontinuous, arcuate flux directing slots 342 which cooperate with the arcuate slots 332 in the housing member 328 to improve magnetic attraction and thus force generation between the electromagnetic coil 324 and the brake rotor 338. The brake rotor 338 is axially slidably and rotationally positively coupled to the output shaft 308 of the electric motor 306 by, for example, sets of interengaging splines or a Woodruff key 344.

When electricity is supplied to the electromagnetic coil 324, it generates magnetic flux which attracts the brake rotor 338 and moves it toward the stationary housing member 328 creating drag between the output shaft 308 and the stationary housing member 328 thereby inhibiting rotation of the output shaft 308. A roller bearing assembly 348 which is mounted and supported by the end plate 304 rotatably supports the terminal portion of the output shaft 308 of the electric motor 306.

A gear train 350 comprising three gears reduces the rotational speed of the electric motor 306 and increases its torque. The gear train 350 includes a first pinion 352 secured to the output shaft 308 of the electric motor 306 and includes gear teeth 354 which engage gear teeth 356 on an intermediate speed reducing gear 360. The intermediate speed reducing gear 360 is rotatably supported upon a stub shaft 362 which is received within suitable blind openings in the housing 302 and the end plate 304. A smaller diameter portion of the intermediate idler gear 360 includes gear teeth 364 which mesh with the gear teeth 366 on a driven gear 370. The driven gear 370 is secured to a drive shaft 372 by a nut 374. The driveshaft 372 is preferably supported upon a ball bearing assembly 376 which is received within the housing 302. The driveshaft 372 includes course threads 378 upon which is received a recirculating ball nut 380. The recirculating ball nut 380 is secured to a hollow master piston 382 which is received within an elongate cylinder 384. A pair of O-ring seals 386 seated within circumferential grooves in the master piston 382 provides a fluid tight seal between the piston 382 and the walls of the cylinder 384. In accordance with conventional practice, as the driveshaft 372 bi-directionally rotates, the recirculating ball nut 380 and the master piston 382 translate left and right within the cylinder 384.

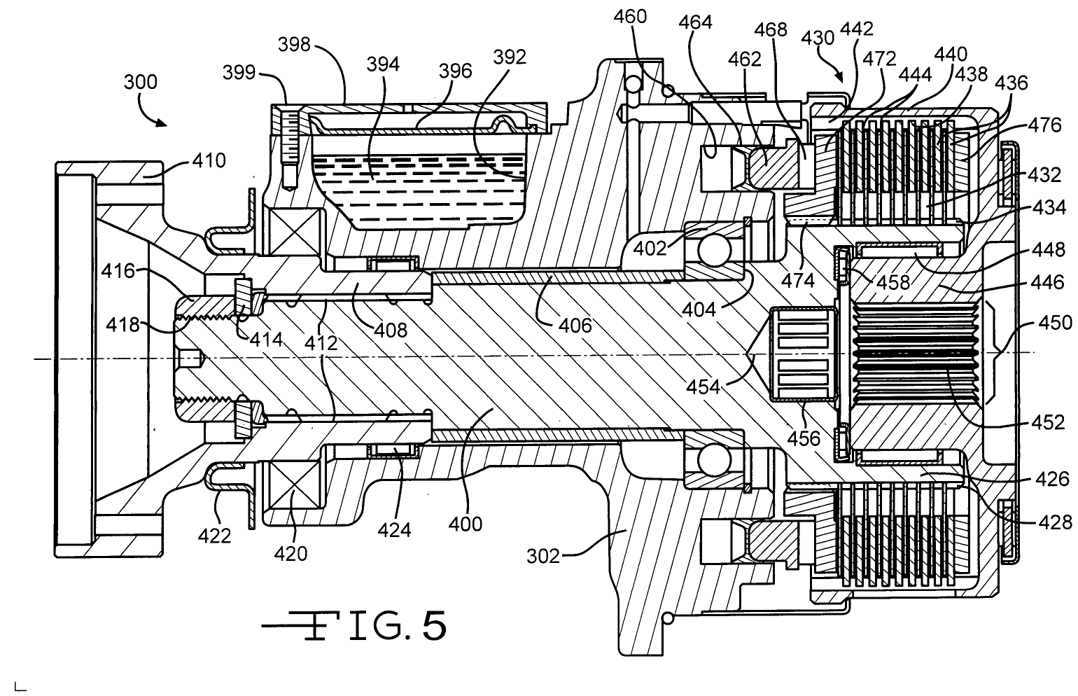

At the end of the elongate cylinder 384 opposite the gear 370 is a fluid passageway 388 which communicates with the driven component of the hydraulic circuit. In fluid communication with the interior of the cylinder 384 when the piston 382 is fully retracted is a fluid passageway 390 which communicates with a fluid reservoir 392 containing a quantity of suitable hydraulic fluid 394 such as oil. A resilient diaphragm and seal 396, preferably fabricated of an elastomeric material, compatible with the hydraulic fluid 394, permits expansion, contraction and consumption of the hydraulic fluid 394 within the reservoir 392 while maintaining a fluid tight seal. The diaphragm and seal 396 cooperates with a cover 398 which is secured to the housing 302 by suitable readily removable fastening means such as one or more threaded fasteners 399 (illustrated in FIG. 5) or a clamp.

Referring now to FIG. 5, the preferred embodiment electromagnetic clutch 300 includes an input shaft 400 which is received and supported within the housing 302 by a ball bearing assembly 402 which is maintained in its axial position against a shoulder 404 by a sleeve or quill 406. The sleeve or quill 406 is maintained in its axial position by a tubular extension 408 of an input flange 410. The input flange 410 is rotationally coupled to the input shaft 400 by a plurality of interengaging male and female splines or gear teeth 412. The input flange is located and secured to the input shaft 400 by a washer 414 and a threaded nut 416 which is received upon a complementarily threaded portion 418 of the input shaft 400. The input flange 410 includes suitable features or attachment points to receive drive from the secondary propshaft 32 (illustrated in FIG. 1) or it may form a portion of a universal joint 34. Between the exterior circular surface of the tubular extension 408 of the input flange 410 and the housing 302 is a fluid tight seal 420 which inhibits passage of foreign material or contaminants into the interior of clutch assembly 300 and prohibits the egress of lubricating fluid from the interior of the clutch assembly 300. A circular guard flange 422 is also seated on and about the exterior cylindrical surface of the flange 410. Preferably, the guard 422 is fabricated of metal or other rugged material and provides protection to the seal 420. A roller bearing assembly 424 is disposed between the tubular extension 408 of the input flange 410 and the housing 302 and freely rotatably supports the input shaft 400.

The input shaft 400 includes an enlarged diameter portion 426 having a plurality of male or exterior splines or gear teeth 428 disposed thereabout. A modulatable friction clutch pack 430 controls the torque throughput of the electrohydraulic clutch assembly 300. The friction clutch pack 430 includes a first plurality of smaller diameter clutch discs or plates 432 having internal or female splines or gear teeth 434 which are complementary to the male splines or gear teeth 428 on the enlarged diameter portion 426 of the input shaft 400. Interleaved with the first plurality of smaller diameter clutch discs or plates 432 is a second plurality of larger diameter clutch discs or plates 436. The larger diameter clutch discs or plates 436 include male or external splines or gear teeth 438 which couple them to an exterior, bell-shaped output housing 440 including interior or female splines or gear teeth 442 which are complementary to the male splines or gear teeth 438 on the clutch discs 436. Secured to at least one face of each of the friction clutch discs or plates 432 and 436 is a thin disc of friction material 444. The bell-shaped housing 440 include an inner annular region 446 which is supported within the enlarged diameter region 426 of the input shaft 400 by a roller bearing assembly 448. The innermost region of the bell-shaped housing 440 defines a through passageway 450 having internal or female splines or gear teeth 452 which receive and engage a drive shaft (not illustrated) of a differential such as the differential assembly 36 or other driven component. Coaxially aligned with the passageway 450 is a counterbore 454 which receives a roller bearing assembly 456 which, in turn, receives a suitably sized terminal portion of the drive shaft to the differential or other driven component. A thrust bearing 458 resides between opposing radial faces of the input shaft 400 and the inner annular region 446 of the bell-shaped housing 440.

Generally axially aligned with the components of the friction clutch pack assembly 430 is an annular hydraulic slave cylinder 460. The annular hydraulic slave cylinder 460 communicates with the hydraulic fluid passageway 388 illustrated in FIG. 4. Disposed within the annular hydraulic slave cylinder 460 is an annular piston 462. The annular piston 462 includes an in-situ molded flexible piston seal 464. The piston seal 464 generally define an “I” in cross-section having regions of increased thickness at the inner and outer diameters or edges of the annular piston 462 and a region of reduced thickness in the intermediate region of the annular piston 462. As pressure within the hydraulic slave cylinder 460 increases, the inner and outer regions of the piston seal 464 are pressed toward the walls of the cylinder 460 and thus improve the fluid seal thereagainst. The flexible piston seal 464 is preferably fabricated of rubber, a synthetic elastomer or other rugged, flexible and long wearing material which is compatible with the hydraulic fluid 394.

On the end of the annular piston 462 opposite the seal 464 is a roller thrust bearing 468. Adjacent the thrust bearing 468 is a circular apply plate 472 having splines 474 which are complementary to and engage the splines 428 on the enlarged diameter region 426 of the input shaft 400. Thus, the apply plate 472 rotates with the input shaft 400. Adjacent the end of the friction clutch pack 430 opposite the apply plate 472 is a circular stop plate 476 which is secured to and rotates with the enlarged diameter portion 426 of the input shaft 400. The stop plate 476 thus functions as a plate or surface against which the clutch plates 432 and 436 of the friction clutch pack assembly 430 are compressed when the slave piston 462 translates to the right in FIG. 5.

Operation of the preferred embodiment electrohydraulic clutch assembly 300 is essentially the same as that of the alternate embodiment clutch assembly 70 with the exception of the electric brake assembly 320. Assuming the brake assembly is not energized, the bidirectional electric motor 306 may be rotated electrically to advance or retract the slave piston 462 and engage or relax the friction clutch pack assembly 430. When a desired position and torque throughput has been achieved, energy to the electric motor 306 is terminated and electricity is provided to the brake assembly 320. By preventing rotation of the output shaft 308 of the electric motor 306, the pressure and torque throughput of the electrohydraulic clutch assembly 300 are maintained.

It should be appreciated that when electrical power to the electrohydraulic clutch assembly 300 is completely, i.e., to both the motor 306 and the brake assembly 320, removed or terminated, the brake 320 will release and pressure and torque throughput will either relax and cease or not be generated. Thus, the fail-safe mode of the clutch assembly 300 is an absence of torque transfer. It should also be appreciated that components such as the pressure sensor 254 of the alternate embodiment clutch assembly 70 may be assembled and utilized in the preferred embodiment clutch assembly 300.

The foregoing disclosure is the best mode devised by the inventors for practicing this invention. It is apparent however, that devices incorporating modifications and variations will be obvious to one skilled in the art of electrohydraulic clutch assemblies. Inasmuch as the foregoing disclosure presents the best mode contemplated by the inventors for carrying out the invention and is intended to enable any person skilled in the pertinent art to practice this invention, it should not be construed to be limited thereby but should be construed to include such aforementioned obvious variations and be limited only by the spirit and scope of the following claims.

We claim:

1. An electrohydraulic clutch assembly comprising, in combination,
an input member and a coaxially disposed output member,
a bidirectional electric motor having a rotor,
an electric brake for selectively inhibiting rotation of said rotor of said electric motor,
a gear train having an input driven by said electric motor and an output,
a ball screw driven by said output and driving a first piston displacing hydraulic fluid,
a second piston translated by said hydraulic fluid said piston having a face and a gasket disposed on to said face, and
a friction clutch pack operably disposed between said input member and said output-member and actuated by said second piston.

2. The electrohydraulic clutch assembly of claim 1 wherein said piston is an annulus and said gasket defines inner and outer walls, and an intermediate region secured to said face of said piston.

3. The electrohydraulic clutch assembly of claim 1 wherein said brake includes an electromagnetic coil and a disc operably coupled to said rotor.

4. The electrohydraulic clutch assembly of claim of 1 further including a pressure sensor for providing a signal representing a pressure of hydraulic fluid generated by said first piston.

5. The electrohydraulic clutch assembly of claim 1 further including a microprocessor having an output adapted to bi-directionally drive said electric motor.

6. The electrohydraulic clutch assembly of claim 1 wherein said friction clutch pack includes a first plurality of clutch plates coupled to said input member and a second plurality of clutch plates interleaved with said first plurality of clutch plates and coupled to said output member.

7. The electrohydraulic clutch assembly of claim 1 further including a circular apply plate and a thrust bearing both disposed between said second piston and said friction clutch pack.

8. An electrohydraulic clutch assembly comprising, in combination, an input member and a coaxially disposed output member,
an electric motor having an output,
an electric brake operatively coupled to said output of said motor,
a master piston,
a rotary motion to linear motion transducer operably driven by said output of said electric motor and driving said master piston,
a friction clutch pack operably disposed between said input member and said output member, and
an annular slave piston in fluid communication with said master piston and acting upon said friction clutch pack.

9. The electrohydraulic clutch assembly of claim 8 wherein said brake includes an electromagnetic coil and a brake disc rotating with said output.

10. The electrohydraulic clutch assembly of claim 8 wherein said slave piston includes an annular gasket secured thereto.

11. The electrohydraulic clutch assembly of claim of 8 further including a pressure sensor for providing a signal representing a pressure of hydraulic fluid generated by said master piston.

12. The electrohydraulic clutch assembly of claim 8 further including a microprocessor having an output for bi-directionally driving said electric motor.

13. The electrohydraulic clutch assembly of claim 8 wherein said friction clutch pack includes a first plurality of clutch plates coupled to said input member and a second plurality of clutch plates interleaved with said first plurality of clutch plates and coupled to said output member.

14. The electrohydraulic clutch assembly of claim 8 further including a circular apply plate and a thrust bearing both disposed between said slave piston and said friction clutch pack.

15. An electrohydraulic clutch assembly for motor vehicle drivelines, comprising, in combination,
an electric motor having a bi-directionally rotating output,
means associated with said rotating output for selectively inhibiting rotation thereof.
a gear train having in input driven by said rotating output of said electric motor and an output,
a ball screw assembly driven by said output of said gear train,
a first piston bi-directionally translated by said ball screw assembly,
a second piston in fluid communication with said first piston and having a gasket at one end, and
a friction clutch pack having an input and an output and acted upon by said second piston.

16. The electrohydraulic clutch assembly of claim 15 wherein said means for selectively inhibiting rotation of said rotating output includes a brake having a brake disc rotating with said rotating output.

17. The electrohydraulic clutch assembly of claim 15 wherein said inhibiting means includes a wrap spring disposed within a cylindrical passageway and extending between a drive hub and a driven pinion, wherein said drive hub and said driven pinion including a coupling accommodating limited relative rotation.

19. The electrohydraulic clutch assembly of claim of 15 further including a pressure sensor for providing a signal representing a pressure of hydraulic fluid generated by said master piston.

20. The electrohydraulic clutch assembly of claim 15 further including a microprocessor having an output adapted to bi-directionally drive said electric motor.

21. The electrohydraulic clutch assembly of claim 15 wherein said friction clutch pack includes a first plurality of clutch plates coupled to said input member and a second plurality of clutch plates interleaved with said first plurality of clutch plates and coupled to said output member.

22. The electrohydraulic clutch assembly of claim 15 wherein said output of said friction clutch pack provides drive torque to a differential in a motor vehicle driveline.

23. The electrohydraulic clutch assembly of claim 15 further including a circular apply plate and a thrust bearing both disposed between said second piston and said friction clutch pack.
